(19) United States
(12) Patent Application Publication
(10) Pub. No.: US 2007/0200060 A1
(43) Pub. Date: Aug. 30, 2007

(54) Pulsed internal lock mass for axis calibration

(76) Inventors: Charles William Russ IV, Sunnyvale, CA (US); Steven Michael Fischer, Hayward, CA (US); James Leo Bertsch, Palo Alto, CA (US)

Correspondence Address: AGILENT TECHNOLOGIES INC., INTELLECTUAL PROPERTY ADMINISTRATION,LEGAL DEPT., MS BLDG. E P.O. BOX 7599, LOVELAND, CO, 80537, US

(21) Appl. No.: 11/365,641

(22) Filed: Feb. 28, 2006

(51) Int. Cl. H01J 49/04

(52) U.S. Cl. 250/288; 250/282; 250/252.1

(57) ABSTRACT

A method and apparatus for calibrating a mass spectrometry system in which lock mass ions are introduced into the transport region of a mass spectrometer intermittently in a pulsed manner and analyte ions and/or lock mass ions are then detected at the mass analyzer. In one embodiment, analyte ions are also introduced into the transport region of the mass spectrometer from the analyte ion source intermittently in a pulsed manner.

### BACKGROUND INFORMATION

Lock masses are often used to calibrate mass spectrometer instruments during operation in real time. They may be introduced into a mass spectrometer either externally or internally. In external introduction, the lock masses may be introduced with or in the vicinity of the analytes at or near the ion source of the mass spectrometer so that the lock masses are ionized by the same mechanism as the analytes. In internal introduction, lock mass ions are generated separately and introduced downstream from the analyte ion source either via a capillary or directly into the ion optics region of a vacuum stage of the mass spectrometer. Internal introduction, which is described in U.S. Pat. Nos. 6,649,909 and 6,797,947 to Russ IV et al., and in the commonly assigned and co-pending U.S. patent application Ser. No. [ ] to Fischer et al. entitled “Lock mass Introduction via a Capillary”, has the advantages that the lock mass ions are formed independently and thus do not affect analyte ion sample integrity or analyte ion generation. In addition, the lock masses can be generated and introduced independently of the type of source used to ionize the analytes.

While internal lock mass introduction has proved to be an extremely useful technique, it sometimes presents problems of interference between the analyte ions and the lock mass ions both pre- and post-detection. Firstly, analyte ions may be suppressed by the lock mass due to charge, chemical and collisional effects. Additionally, lock mass ions may overlap with an analyte ion of interest in a mass spectrum and thus interfere with the analysis of the analyte.

Conversely, there are instances in which analyte ions interfere with the accurate mass assignment of the lock mass, as the following example illustrates. Let us say that an analyte main peak has a mass of 550 AMU, a lock mass has a mass of 600 AMU, with an abundance of 10% of the analyte main peak, and a contaminant appears in the spectrum with a mass of 600.03 AMU, and an abundance of 1% of the main peak. The difference between the lock mass and the contaminant mass may not be resolvable even using a high-resolution instrument such as a time-of-flight (TOF) mass analyzer. An analysis algorithm may not be able to distinguish the lock mass peak from the contaminant peak, and the lock mass may therefore be assigned a centroid value combining the peaks, resulting in an error of up to 5 ppm (parts per million). If the contaminant is more abundant, the error can be substantially larger.

Such interference from contaminants within a sample or instrument is usually not as problematic when large-molecule lock masses are used because of the lower frequency of naturally occurring high-mass contaminant molecules. However, large biological molecules tend to cover a wide spectrum because of their numerous isotopic variants. One or more isotopic variants can overlap with a lock mass peak and interfere with its mass assignment in a manner analogous to contamination.

### SUMMARY OF THE INVENTION

In one aspect, the present invention provides a method of calibrating a mass spectrometry system that includes introducing lock mass ions into the transport region of a mass spectrometer intermittently in a pulsed manner and detecting analyte ions and/or lock mass ions at the mass analyzer. In one embodiment, analyte ions are also introduced into the transport region of the mass spectrometer from the analyte ion source intermittently in a pulsed manner.

In another aspect, the present invention provides a mass spectrometer that includes an analyte ion source for providing analyte ions, a mass analyzer situated downstream from the analyte ion source, a transport region situated between the analyte ion source and the mass analyzer, a lock mass ion source situated adjacent to the transport region, and means for introducing lock mass ions from the lock mass ion source into the transport region of the mass spectrometer intermittently in a pulsed manner.

### BRIEF DESCRIPTION OF THE DRAWINGS

FIG. 1A is a schematic illustration of a mass spectrometry system according to an embodiment of the present invention.

FIG. 1B is a schematic illustration of an alternative embodiment of a mass spectrometer according to an embodiment of the present invention.

FIG. 1C is a schematic illustration of another embodiment of a mass spectrometer according to an embodiment of the present invention having a GCI/S interface.

FIG. 1D is a schematic illustration of a further embodiment of a mass spectrometer according to an embodiment of the present invention having a GCIMS interface and an upstream lock mass source.

FIG. 2A is a graph of ion magnitude versus time showing example on pulses of the analyte and lock mass ion streams according to an embodiment of the present invention.

FIG. 2B illustrates the repetition of the pulses shown in FIG. 2A.

FIG. 2C shows another graph of ion magnitude versus time illustrating an analyte ion stream that is not pulsed with a pulsed lock mass ion stream.

FIG. 3A is an example analyte spectrum generated without lock mass spectral data according to the present invention.

FIG. 3B is an example lock mass peak generated without analyte spectral data according to the present invention.

### DETAILED DESCRIPTION

A. Definitions

In describing and claiming the present invention, the following terminology will be used in accordance with the definitions set out below.

As used in this specification and the appended claims, the singular forms “a,” “an,” and “the” include plural referents unless the context clearly dictates otherwise.

It is also noted at the outset that the terms “lock mass” and “reference mass” are interchangeably used in the art to describe a known mass used to calibrate a mass spectrometer instrument. The term “lock mass” is used throughout herein, but this term is meant to encompass the term “reference mass” as used and understood by those skill in the art as well.

The term “pulsed manner” as used herein means operating in an “on” or “high” state for a certain duration, followed by an “off” or “low” state followed for another duration which may or may not be different from the duration of the on state (or vice versa). A number of on and off states may follow one another in a series.

The terms “on pulse” and “off pulse” refer to the “on” or “high” states and “off” or “low” states of a parameter during operation in a pulsed manner, respectively.

The term “adjacent” means near, next to or adjoining. Something adjacent may also be in contact with another component, surround (i.e. be concentric with) the other component, be spaced from the other component or contain a portion of the other component.

The term “analyte ion source” refers to any source that produces analyte ions.

The term “lock mass ion source” refers to any source that produces lock mass ions.

The term “electrospray ionization source” refers to a nebulizer and associated parts for producing electrospray ions. The nebulizer may or may not be at ground potential. The term should also be broadly construed to comprise an apparatus or device such as a tube with an electrode that can discharge charged particles that are similar or identical to those ions produced using electrospray ionization techniques well known in the art.

B. Description

The present invention enables lock mass ions and analyte ions to be introduced into the transport region of a mass spectrometer in a pulsed manner. One benefit of such pulsed operation is that separate mass spectra can be generated for the analytes and lock mass, i.e., a spectrum of the analyte ions that does not include a significant lock mass ion signal, and, if desired, a spectrum of the lock mass that does not include a significant analyte ion signal.

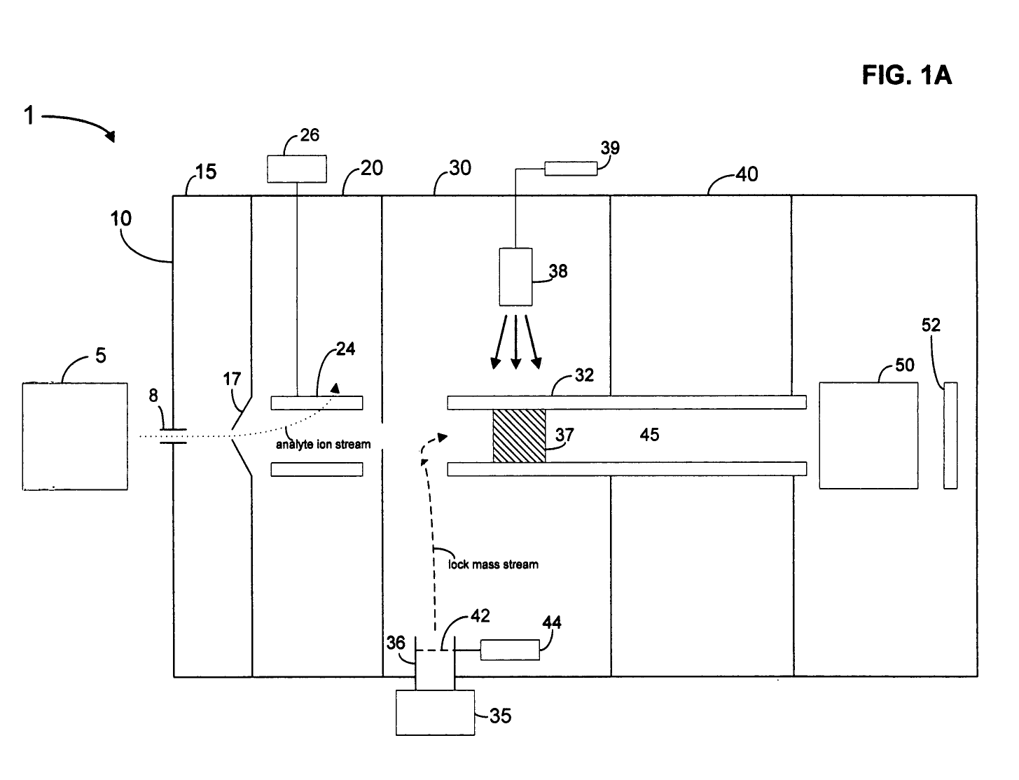

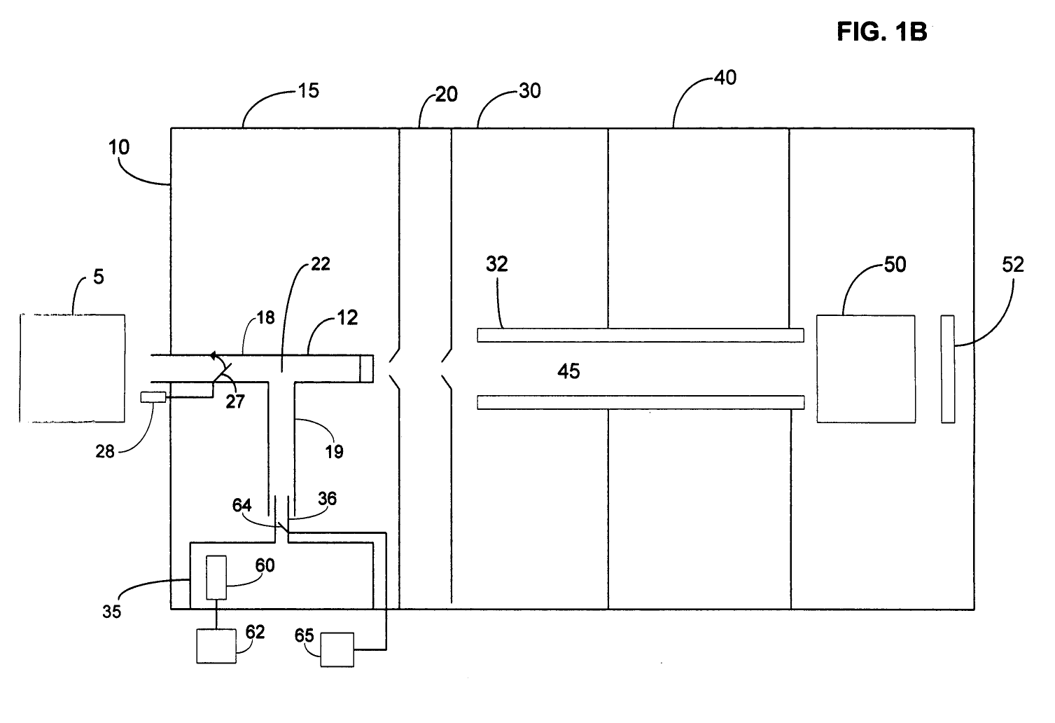

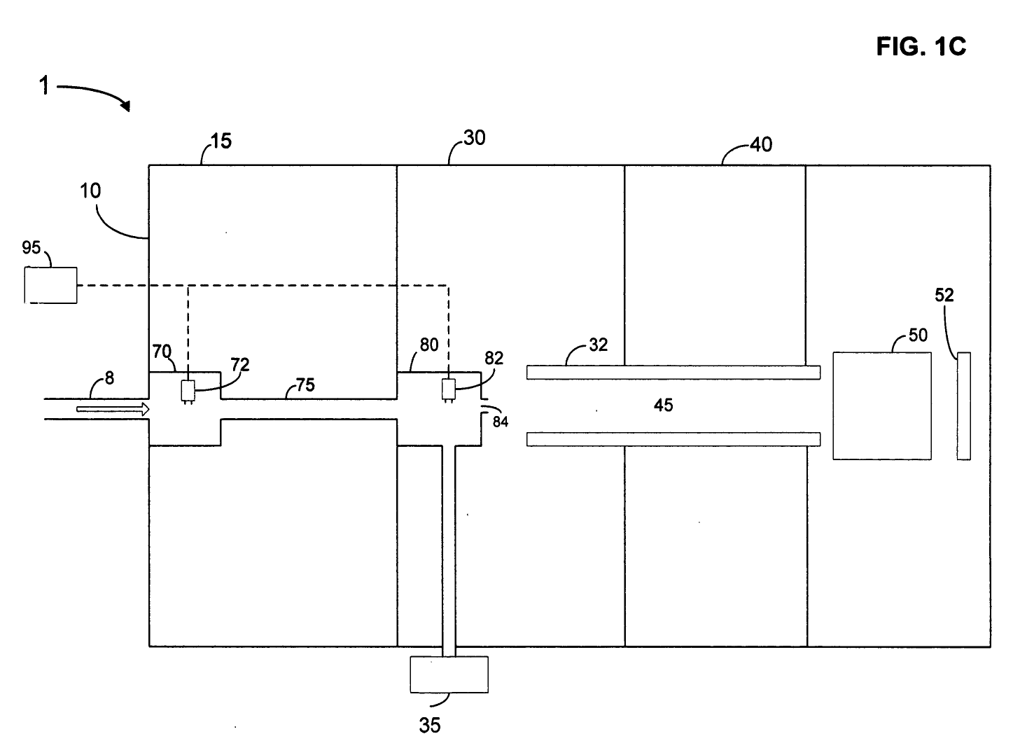

FIG. 1A illustrates an exemplary mass spectrometry system 1 that optionally provides pulsed internal lock mass ion introduction and also optionally provides pulsed analyte ion introduction according to the present invention. As shown, a mass spectrometry system 1 includes an analyte ion source 5 and a mass spectrometer 10. The ion source 5 generates ions from a sample of analyte compounds which may be provided to the ion source using a liquid (LC) or gas chromatography (GC) interface, for example. The ion source 5 may comprise one or more ionization modes, including atmospheric pressure ionization techniques such electrospray, atmospheric pressure photoionization (APPI), atmospheric pressure chemical ionization (APCI), and atmospheric pressure matrix-assisted laser desorption ionization (AP-MALbI), among other known types.

Analyte ions generated at ion source 5 are guided by electric fields and gas dynamics through an aperature of an interface 8, such as a capillary or skimmer, to a first vacuum stage 15 of the mass spectrometer 10, which may be maintained at a pressure of several torr. Within the first vacuum stage 15, the analyte ions undergo a free jet expansion. A skimmer 17 at the downstream end of the first vacuum stage 15 intercepts the jet expansion, and a portion of the analyte ions having a trajectory approximately along the central axis of the mass spectrometer 10 pass through the skimmer 17 into a second vacuum stage 20, which may be maintained at a pressure about one order of magnitude below the pressure in the first vacuum stage 15.

The second vacuum stage includes ion optics 24, which may comprise a multipole rod set and other electrodes and/or electrostatic lens which are known in the art for producing precise electric fields. An RF voltage from RF/DC voltage source 26 is applied to the ion optics 24 which focuses the analyte ions toward the central axis of the spectrometer. A switchable DC voltage from source 26 may also be applied to the ion optics which, as occurs in normal scanning modes, can be used divert the analyte ions in an orthogonal direction away from the central axis (shown by the curved portion of the dotted line in FIG. 1A) when it is desired to shut off the analyte ion stream for a duration, resulting in an analyte ion ‘off’ pulse. It is noted that diverting the analyte ion stream using ion optics in the second vacuum stage represents only one implementation from any number of different ways that an analyte off pulse can be effectuated. For example, a repeller plate may also be incorporated in the second vacuum stage (not shown), which may be turned on to stop the forward trajectory of the analyte ions, also resulting in an analyte ion ‘off’ pulse.

During an analyte on pulse, when transmission of the analyte ions through the mass spectrometer 10 is desired, RF-only fields are applied to the ion optics 24, and the analyte ions pass through a further skimmer or aperture 26 to a third vacuum stage 30, which is maintained at a pressure one or more orders of magnitude below the second vacuum stage, such as in the millitorr range. The third vacuum stage 30 includes ion optics elements 32, which should be interpreted to include all ion optics elements from the third vacuum stage to the mass analyzer 50, including skimmer elements, electrodes, lenses, and multipole elements. The region within the ion optics 32 through which ions are carried toward the mass analyzer 50 is denoted herein as the utransport region” 45.

A source of lock mass ions 35 is situated adjacent to the ion optics 32. The lock mass source 35 may be maintained at a higher pressure than the third vacuum stage so that lock mass molecules in a gaseous state flow through an inlet 36 into the third vacuum stage 30, where they are drawn into the ion optics 32 by gas dynamics and the flow of analyte ions (when the analyte ion stream is present) into ionization region 37. In the embodiment shown, the function of source 35 is to supply lock mass molecules to the ionization region 37 within ion optics 32, where the ion optics are subjected to emissions from an ionization device 38. The lock mass molecules can be any chemical species that is volatile under reduced pressure and/or elevated temperature levels, chemically stable and ionizable when exposed to photons or an ionized reagent gas such as acetone. Numerous organic chemicals such as fluorinated phosphazines and polyethylene glycols are examples of compounds commonly used as lock masses. Typically these molecules have ionization potentials in the range of 7.5 to 12 eV, making them particularly suitable for ionization by ultraviolet radiation. The ionization device 38 may comprise a photon source, such as a vacuum ultraviolet source, and is positioned in close proximity to the ionization region 37 so that maximum radiation is delivered to the region. The ionization source 38 receives electrical power from an external energy source 39. Other types of ionization sources may also be employed in this context such as a laser device or an electron source.

In the embodiment of shown in FIG. 1A, the lock mass molecules are ionized within the mass spectrometer 10; there are consequently two distinct ways to introduce lock mass ions into the transport region of the mass spectrometer in a pulsed manner according to this embodiment: introducing the non-ionized lock mass molecules intermittently; and introducing the lock mass molecules continuously, and then ionizing the lock mass molecules intermittently. There are numerous ways to implement each of these techniques. For example, as regards the first technique, an actuator 42 may be employed to close off the supply of the lock mass ions to the ionization region. The actuator may comprise a mechanical element responsive to a signal from a controller 44 that closes off the inlet 41, and/or a pneumatic device that applies a counterflow of gas to divert gaseous lock mass molecules so that they cannot exit from the inlet or otherwise do not reach the ionization region 37, for example. The second technique may include switchably operating the ionization source via power source 39 so that lock mass molecules are ionized intermittently in a pulsed manner. Alternatively, if the ionization device is a photon source, an electrically-driven shutter may be positioned on the end of the photoionization source and actuated intermittently in a pulsed manner to prevent radiation from emerging from the source during a lock mass ion off pulse.

FIG. 1B illustrates another embodiment of a mass spectrometry system according to the present invention that introduces lock mass ions via a capillary upstream from the vacuum stages of the mass spectrometer. In this case, the lock mass ions are generated in the lock mass source chamber 35 rather than in the mass spectrometer 10 itself. This allows different modes of pulsed operation. The mass spectrometer 10 of the embodiment shown in FIG. 1B includes a capillary 12 having two separate inlets 18, 19 that meet at a junction 22. This junction may be implemented as a tee junction so that the inlets 18, 19 are at approximately right angles to one another. Analyte ions generated at analyte ion source 5 are introduced into inlet 18 of the capillary 12. During an analyte on pulse, the analyte ions continually enter the capillary 12 and pass through the junction 22 toward the vacuum stages of the mass spectrometer 10. To pulse the analyte ion stream, the analyte stream may be blocked in its passage through the capillary 12 before the junction 22 using a rotating shutter 27 or similar mechanical device that can open or block the passage depending on an electrical signal from a controller 28, or electric fields can be used to repel or otherwise divert analyte ions from flowing through the capillary. It is noted that these techniques for pulsing the analyte stream are merely exemplary and different techniques can be employed by those of skill in the art. Whichever technique is employed, it is important that the analyte ion stream be shut off or turned on quite rapidly with as little time required for ramping up or down as possible.

Lock mass ion source chamber 35 includes a lock mass ionization device 60 which operates on lock masses within the source so that the source can release lock mass ions without the need for an external ionization device within the mass spectrometer 10. As described in the co-pending patent application, Ser. No. ______ to Fischer et al., the lock mass ionization device 60 can comprise a variety of ionization modes corresponding to the nature of the lock mass material used. For example, an electric discharge or an ultraviolet photon source can be used to ionize a gaseous stream of lock mass molecules emerging from a bubbler, an electrospray source may be used to nebulize and ionize a lock mass solution provided from an external reservoir; or a laser ionization device can be used to desorb and ionize lock masses embedded in a crystalline matrix (MALDI). Lock mass ion source 35 is coupled to the capillary 12 via inlet 36. The lock mass source 35 may be maintained at a pressure above the pressure prevailing in the capillary 12 so that lock mass ions produced in the chamber 35 may be forced out via the inlet 36 to the junction 22 and thence into the vacuum stages of the mass spectrometer 10.

Lock mass ions may be introduced into the mass spectrometer in a pulsed manner by either generating the lock mass ions intermittently in a pulsed manner, by generating the lock mass ions continuously and then releasing them intermittently in a pulsed manner into the capillary 12, or some combination of the techniques. Again, there are a number of ways to generate lock mass ions in a pulsed manner. For example, if the ionization device 60 includes a MALDI apparatus with a lock mass sample embedded in a confined area on the surface of a substrate, the substrate can be rotated so that the laser strikes the area bearing the sample periodically for a short duration, ionizing lock mass ions in a pulsed manner. Similarly, if the ionization device 60 includes either a corona discharge needle or a photon source, these devices can be turned on and off in a pulse sequence using a switchable power source 62, and ion generation will follow this sequence closely with only a small time delay. Alternatively, continuously generated lock mass ions can be introduced into the capillary 12 from the lock mass source chamber 35 in a pulsed manner by closing off the inlet 36 using an electromechanical shutter element 64 operating using controller 65, by diverting the gaseous flow of the lock mass ions via gas dynamics, employing a switchable repeller electrode, etc.

FIG. 1C illustrates another embodiment in which lock mass ions are introduced by a gas chromatography (GC/MS) coupling. Separated analytes are introduced in a gaseous state through capillary 8 into an ionization chamber 70 positioned within the first vacuum stage 15 of the mass spectrometer 10. By introducing the analytes in gaseous phase, certain types of ionization mechanisms such as electron-impact ionization may be used, which would otherwise be infeasible. As the analytes enter the ionization chamber 70 they flow past a switchable ionization device 72, which may be an electron-emission filament (electron impact), a corona needle (APCI), or a photon source (APPI). The ionization device 72 may be switched on an off via a control unit 95. When the ionization device 72 is turned on, analytes are ionized and flow downstream through conduit 75 into a second ionization chamber 80 within downstream vacuum stage 30. The second ionization chamber is also coupled via outlet 36 to a lock mass source 35. Lock masses flow in a gaseous state to the second ionization chamber where they flow past a switchable second ionization device 80, which can also comprise an electron filament, corona needle or photon source (also controllable via control unit 95). During an analyte ON pulse, the second ionization device is switched off, and vice versa during an analyte OFF pulse/lock mass ON pulse. All species that are present within the second ionization chamber are drawn downstream through outlet 84 into the ion guide 32 and mass analyzer 50.

FIG. 1D illustrates another GC/IMS embodiment in which lock mass ions are introduced upstream from the analyte ion source. In this case, a switchable lock mass source 35 including an ionization device 60 is positioned upstream of the mass spectrometer 10, and lock mass ions are introduced into the capillary 8 which is also coupled to the output of a GC column (not shown). Analytes from the GC column are ionized within ionization chamber 70 in the same manner as discussed with respect to FIG. 1C.

Once analyte ions and/or lock mass ions enter pass through the initial vacuum stages 15, 20 into the transport region of the mass spectrometer 10, they are guided by ion optics through one or more further vacuum stages 40, in which excess neutral gas is stripped from the ions, into a mass analyzer 50 where the ions are differentially filtered according to their respective mass-to-charge ratios and then detected via impact at detector 52. It is noted that within the transport region 45, the lock mass ions and the analyte ions are subjected to substantially the same collisional cooling and focusing as the analyte ions so that they are conditioned in the same way prior to detection.

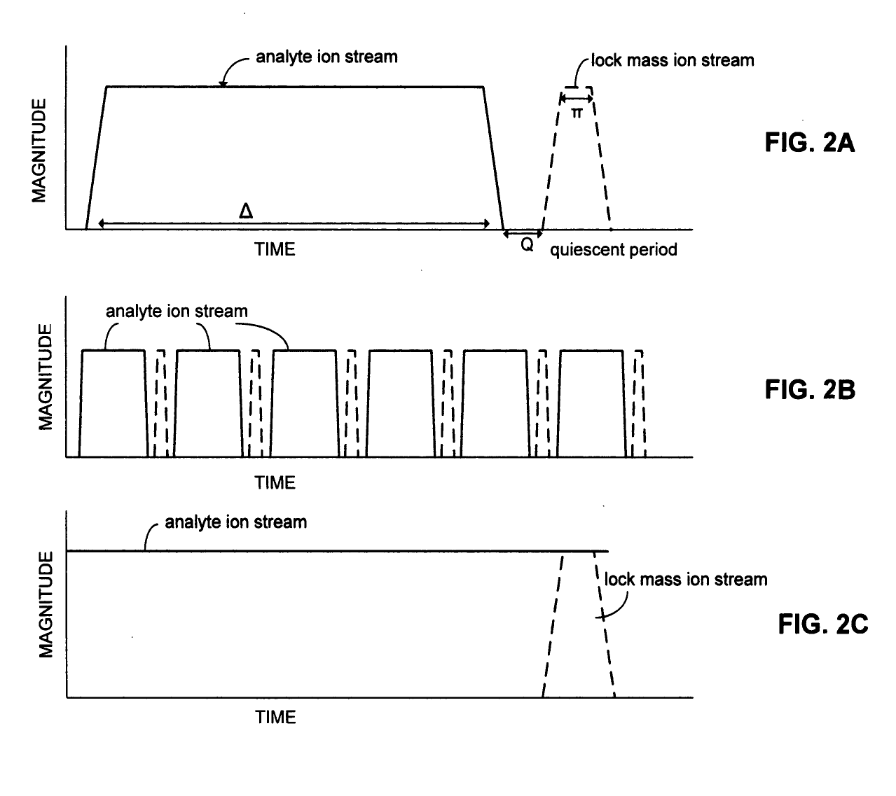

FIG. 2A is a schematic graph of the magnitudes of the analyte ion stream and lock mass ion stream within the transport region of the mass spectrometer that illustrates an example of the pulsing of the ion streams according to the present invention. In this example, the analyte ions are introduced into the transport region of the mass spectrometer for a period of time (Δ), then stopped from being introduced therein by activating a mechanism for blocking, diverting, or otherwise preventing the analyte ions from being introduced into the transport region by one or more of the techniques described above, for example. Thereafter, after a quiescent period (Q) during which the concentration of remaining analyte ions and/or contaminating species within the mass spectrometer drops to an extremely low level, the lock mass ion stream is turned on for a period (π). The lock mass ion stream is then turned off at the end of the period by one or more of the techniques discussed above, for example. In this manner, the analyte ion stream is in an on pulse while the lock mass is off (the off period may be considered an ‘off pulse’ for the purposes herein), and vice versa. This allows an analyte ion signal to be obtained and detected without an appreciable lock mass ion signal during the period (Δ), and a lock mass ion signal to be obtained and detected without an appreciable analyte ion signal during the period (π). It is noted that the on pulses have finite ramping up and ramping down times, which are generally fairly minute, on the order of microseconds.

Since the analyte ion signal is generally the signal of interest, and high-throughput applications often require the mass spectrometer to be operating in an analyte analysis mode for much of the time, it is generally useful to set the period of the analyte on pulse (Δ) to be significantly larger than the period of the lock mass ion on pulse (π) and also the period of the quiescent period (Q). The length of the latter (π) and (Q) are set based on instrumental and physical constraints as to the amount of time required to obtain an accurate lock mass ion signal measurement and to substantially empty the instrument of the unwanted species (either analyte or lock mass ions depending on which is being measured) between on pulses. For example, the analyte on pulse may represent 90 percent of the total, with the lock mass ion on pulse period (π) and the quiescent period (Q) each at 5 percent of the total sequence shown in FIG. 2A. This is merely an illustrative example, and it is expected that the absolute and relative lengths of the periods will be modified by the skilled practitioner to fit the application at hand. The length of the lock mass ion pulse will also depend to some extent on the efficiency of the mechanism employed to ionize the lock mass molecules; somewhat longer lock mass on pulse periods may be used to accumulate a sufficient number of ions when the ionization efficiency is low or drops from a prescribed level. As an example, the length of the lock mass ion on pulse period (π) may range from 10 to 100 ms, and can be performed every 10 seconds in a typical system (in which case the relative length of the lock mass ion on pulse will be less than 5 percent of the total cycle time), every second in a less stable system, or every minute in a more stable system.

As shown in FIG. 2B, the sequence including the analyte ion on pulse, quiescent period and lock mass ion on pulse sequence shown in FIG. 2A can be repeated indefinitely (with additional quiescent periods between repetitions to clear out the lock mass ion signal). Operating the ion streams in a pulsed manner in this repetitive way allows for near real-time calibration of the mass spectrometer, since lock mass readings are made once per sequence, and the length of time between readings can be set short enough to effectively capture drifts in instrumental parameters and also to gather a large series of lock mass m/z data for establishing an accurate calibrant measurement (by moving averages, removing erroneous or outlying measurements, for example).

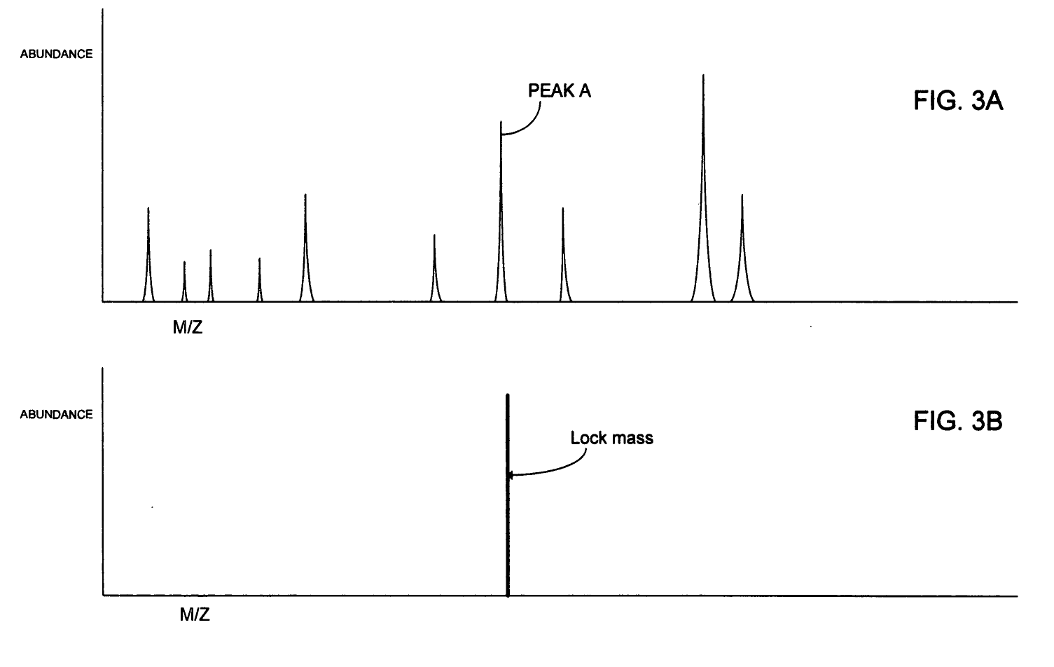

In addition, according to this technique, as the analyte ion and lock mass ion streams are detected sequentially, the data streams output by the detector can be separated, so that an analyte mass spectrum can be generated without the lock mass spectral data, and vice versa. FIGS. 3A and 3B illustrate such spectra, with FIG. 3A illustrating an example analyte spectrum having a number of different peaks corresponding to different chemical species, and FIG. 3B illustrating a lock mass spectrum showing a single peak corresponding to the m/z value of a single lock mass molecule. In practice, two different lock masses are often used to facilitate calibration, but for purposes of illustration, only one lock mass is shown in the spectrum of FIG. 3B. In the figure, the m/z value of the lock mass ion is close to the m/z value of one of the analyte peaks in FIG. 3A (Peak A). Thus, if the spectra were combined, the lock mass peak and Peak A would likely interfere, making it difficult to determine the identity of the species represented by peak A and an accurate mass assignment of the lock mass ion.

While pulsing both the analyte ion stream and the lock mass ion stream is advantageous for some applications, it is not always necessary to pulse both streams, and in particular, there may be applications, such as high-throughput analysis, in which it is not desirable to pulse the analyte ion stream. An example of this is shown in FIG. 2C, in which the analyte ion stream stays constant while the lock mass ion stream is pulsed in a manner similar to that shown in FIGS. 2A and 2B. In this embodiment, there will be some presence of analyte ions in the lock mass spectrum, but this may not be a concern because of the unlikelihood of interference between the lock mass and the analyte, for example.

It is emphasized that the embodiments of pulsed operation of the analyte ion stream and lock mass ion stream described above are exemplary and that the pulsed operation can occur in numerous other ways. For example, instead of generating a lock mass ion on pulse with every analyte ion on pulse in a repetitive sequence as shown in FIG. 2B, a lock mass pulse may be generated for every other analyte ion pulse, every fourth analyte ion pulse, etc, depending upon the pertinent application.

Having described the present invention with regard to specific embodiments, it is to be understood that the description is not meant to be limiting since further modifications and variations may be apparent or may suggest themselves to those skilled in the art. It is intended that the present invention cover all such modifications and variations as fall within the scope of the appended claims.

It is also noted that all control elements or controllers describe above may be implemented electronically, and may be implemented in a single processor element employed using hardware and/or software instructions.

What is claimed is:

1. A method of calibrating a mass spectrometry system including an analyte ion source, a transport region positioned downstream from the analyte ion source and a mass analyzer positioned downstream from the transport region, the method comprising:
introducing lock mass ions into the transport region of the mass spectrometer intermittently in a pulsed manner; and
detecting at least one of analyte ions and lock mass ions at the mass analyzer.

2. The method of claim 1, further comprising:
introducing analyte ions into the transport region of the mass spectrometer from the analyte ion source intermittently in a pulsed manner.

3. The method of claim 2, wherein the lock mass ions and the analyte ions are introduced into the transport region alternately, with an on pulse of the lock mass ions being synchronous with an off pulse of the analyte ions, and an on pulse of the analyte ions being synchronous with an off pulse of the lock mass ions.

4. The method of claim 3, wherein the on pulse of the analyte ions is substantially longer than the on pulse of the lock mass ions.

5. The method of claim 3, further comprising:
setting a rest period in between an on pulse of the analyte ions and an on pulse of the lock mass ions in which streams of analyte ions and lock mass ions are turned off.

6. The method of claim 3, further comprising:
adjusting a period of the on pulses of the analyte ions and lock mass ions.

7. The method of claim 1, further comprising:
alternately activating and deactivating an electric field, the activated electric field deflecting the lock mass ions and preventing introduction of the lock mass ions into the transport region.

8. The method of claim 1, further comprising:
generating the lock mass ions intermittently in a pulsed manner; and
injecting the lock mass ions into the transport region as they are generated.

9. The method of claim 8, further comprising:
alternately switching an ionization mechanism between on and off states to intermittently generate lock mass ions.

10. The method of claim 8, further comprising:
exposing lock mass samples to an ionization mechanism intermittently in a pulsed manner.

11. The method of claim 10, wherein the ionization mechanism includes a laser beam which is configured to impact lock mass samples intermittently in a pulsed manner.

12. The method of claim 1, further comprising:
obtaining a mass spectrum reflecting a detection of analyte ions without lock mass ions.

13. A mass spectrometer comprising:
an analyte ion source for providing analyte ions;
a mass analyzer situated downstream from the analyte ion source;
a transport region situated between the analyte ion source and the mass analyzer;
a lock mass ion source situated adjacent to the transport region; and
means for introducing lock mass ions from the lock mass ion source into the transport region of the mass spectrometer intermittently in a pulsed manner.

14. The mass spectrometer of claim 13, wherein the transport region includes ion optics for guiding analyte ions, and the lock mass ions are introduced into the ion optics from the lock mass ion source.

15. The mass spectrometer of claim 13, wherein the transport region includes a capillary having a first end coupled the analyte ion source and a junction for receiving lock mass ions from the lock mass ion source.

16. The mass spectrometer of claim 13, further comprising:
means for introducing analyte ions from the analyte source into the transport region intermittently in a pulsed manner.

17. The mass spectrometer of claim 13, wherein the means for introducing lock mass ions from the lock mass ion source into the transport region of the mass spectrometer intermittently in a pulsed manner includes an electric field.

18. The mass spectrometer of claim 13, wherein the means for introducing lock mass ions from the lock mass ion source into the transport region of the mass spectrometer intermittently in a pulsed manner includes a flow of gas.

19. The mass spectrometer of claim 13, wherein the means for introducing lock mass ions from the lock mass ion source into the transport region of the mass spectrometer intermittently in a pulsed manner includes further means for intermittently generating lock mass ions in a pulsed manner.

20. The mass spectrometer of claim 19, wherein the means for intermittently generating lock mass ions in a pulsed manner includes a switchable lock mass ionization device.

21. The mass spectrometer of claim 20, wherein the switchable lock mass ionization device includes one of an electric discharge and a photon source.

22. The mass spectrometer of claim 16, wherein the means for introducing analyte ions from the analyte source into the transport region intermittently in a pulsed manner includes further means for intermittently generating analyte ions in a pulsed manner.

23. The mass spectrometer of claim 22, wherein the means for intermittently generating analyte ions in a pulsed manner includes a switchable analyte ionization device.

24. The mass spectrometer of claim 16, wherein the lock mass ions and the analyte ions are introduced into the transport region alternately, with an on pulse of the lock mass ions being synchronous with an off pulse of the analyte ions, and an on pulse of the analyte ions being synchronous with an off pulse of the lock mass ions.

25. The mass spectrometer of claim 24, wherein the on pulse of the analyte ions is substantially longer than the on pulse of the lock mass ions.

26. A mass spectrometry system comprising:
a conduit for receiving analytes in a gaseous phase;
a first vacuum stage, the vacuum stage including a first ionization chamber coupled to the conduit and including a first ionization device;
a lock mass source;
a second vacuum stage downstream from the first vacuum stage including a second ionization chamber coupled to the conduit and to the lock mass source and having a second ionization device;
means for switching the first and second ionization devices alternately in a pulsed manner.

27. The mass spectrometry system of claim 26, wherein the first ionization device comprises an electron emitter.

28. The mass spectrometry system of claim 26, wherein the first ionization device comprises a corona needle.

29. The mass spectrometry system of claim 26, wherein the first ionization device comprises a photon source.

30. A mass spectrometry system comprising:
a source of lock mass ions including a first ionization device;
a conduit for receiving analytes in a gaseous phase and coupled to the source of lock mass ions;
a first vacuum stage, the vacuum stage including an ionization chamber coupled to the conduit and including a second ionization device;
means for switching the first and second ionization devices alternately in a pulsed manner.

31. The method of claim 3, wherein the lock mass ion on pulse ranges from about 10 ms to about 100 ms.

32. The method of claim 31, wherein the lock mass ion is pulsed on at a rate between once per second and once per minute.
